(19) United States
(12) Patent Application Publication
(10) Pub. No.: US 2025/0068297 A1
(43) Pub. Date: Feb. 27, 2025

(54) Gesture-Engaged Virtual Menu for Controlling Actions on an Artificial Reality Device

(71) Applicant: Meta Platforms Technologies, LLC, Menlo Park, CA (US)

(72) Inventors: Aaron SELIG, Belmont, CA (US); Katharine Ann NICHOLS, Louisville, KY (US); Ahad Habib BASRAVI, Oakland, CA (US); Nathaniel LANE, Wrentham, MA (US); James Michael-K O'DONNELL, Pacifica, CA (US); Jeremy EDELBLUT, Alameda, CA (US); Britt MIURA, Menlo Park, CA (US)

(21) Appl. No.: 18/454,334

(22) Filed: Aug. 23, 2023

(51) Int. Cl. G06F 3/0482; G06F 3/01; G06F 3/04847; G06F 3/16

(52) U.S. Cl. CPC G06F 3/0482; G06F 3/017; G06F 3/04847; G06F 3/167

(57) ABSTRACT

Aspects of the present disclosure provide a quick actions menu in an artificial reality (XR) environment that can be accessed by performing a hand gesture detected by an XR device which, in some implementations, can be detected without the use of controllers. Once the menu is open, the user can move her hand while performing the gesture to highlight a particular quick action and can release the gesture on a highlighted action to select the action. In some implementations, the user can drill down into an action on the menu by highlighting the action, then dragging the gesture off of the action away from the menu. To close the quick actions menu, the user can either A) move the gesture off the menu and release the gesture, B) rotate the wrist, or C) explicitly dismiss the menu, such as by using a voice command detected by the XR device.

### TECHNICAL FIELD

The present disclosure is directed to controlling actions on an artificial reality (XR) device via gestures made relative to a virtual menu in an XR environment.

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR (together XR) experiences can be observed by a user through a head-mounted display (HMD), such as glasses or a headset. An MR HMD can have a pass-through display, which allows light from the real-world to pass through a lens to combine with light from a waveguide that simultaneously emits light from a projector in the MR HMD, allowing the MR HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5A is a flow diagram illustrating a process used in some implementations of the present technology for controlling an action, on an artificial reality device, with a gesture made and released relative to a selectable element on a virtual menu.

FIG. 5B is a flow diagram illustrating a process used in some implementations of the present technology for controlling a sub-action, on an artificial reality device, by dragging a gesture off a selectable element in a virtual menu displayed in an artificial reality environment.

FIG. 6A is a conceptual diagram illustrating an example view on an artificial reality device of a virtual menu displayed in an artificial reality environment based on detection of a gesture.

FIG. 6B is a conceptual diagram illustrating an example view on an artificial reality device of a selectable element being highlighted with a gesture on a virtual menu displayed in an artificial reality environment.

FIG. 6C is a conceptual diagram illustrating an example view on an artificial reality device of a further selectable element being displayed in a virtual menu, corresponding to a sub-action of a highlighted selectable element, based on movement of the gesture off of the highlighted selectable element.

FIG. 7A is a conceptual diagram of an example view on an artificial reality device of a virtual menu, having a radial configuration, displayed in an artificial reality environment based on detection of a gesture.

FIG. 7B is a conceptual diagram of an example view on an artificial reality device of particular selectable elements being displayed in a virtual menu based on a forward push motion of a gesture.

FIG. 7C is a conceptual diagram of an example view on an artificial reality device of particular selectable elements being displayed in a virtual menu based on a wrist rotation while performing a gesture.

FIG. 7D is a conceptual diagram of an example view on an artificial reality device of particular selectable elements being displayed in a virtual menu based on a downward motion of a gesture.

The techniques introduced here may be better understood by referring to the following Detailed Description in conjunction with the accompanying drawings, in which like reference numerals indicate identical or functionally similar elements.

### DETAILED DESCRIPTION

Currently, many shortcuts for performing actions on an artificial reality (XR) head-mounted displays (HMD) are made via handheld controllers. Aspects of the present disclosure aim to increase parity between controllers and hands by providing a quick actions menu that can be accessed by performing a gesture, e.g., a pinch gesture facing the user. Once the menu is open, the user can move her hand while performing the gesture to highlight a particular quick action, and can release the gesture on a highlighted action to select the action. The quick actions can be system actions (e.g., recenter user interface, mute or unmute microphone, activate or deactivate passthrough mode, record a video, take a screenshot, launch an assistant, etc.), contextual actions (e.g., while watching a movie, the quick actions can include pause, play, fast forward, rewind, etc.), or user-customized or user-defined actions. In some implementations, the user can drill down into an action on the menu by highlighting the action, then dragging the gesture off of the action away from the menu. For example, the user can highlight a volume icon using a pinch gesture, then drag the gesture off of the volume icon to display a slider to adjust the volume. To close the quick actions menu, the user can either A) move the gesture off of the menu and release the gesture, B) rotate the wrist while making the gesture, or C) explicitly dismiss the menu, such as by using a voice command.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Implementations of the present technology provide specific technological improvements in the field of artificial reality. For example, current XR devices require the use of handheld controllers to display and access system-and application-level menus and options. Some implementations eliminate the need for such controllers by tracking hand gestures using integral cameras to open, use, and close virtual menus. Thus, some implementations reduce the amount of hardware needed to access functions on an XR device. Further, by allowing users to quickly and easily open and close virtual menus using hand gestures, the XR device need not always render the virtual menus, thereby conserving display and processing resources on the XR device.

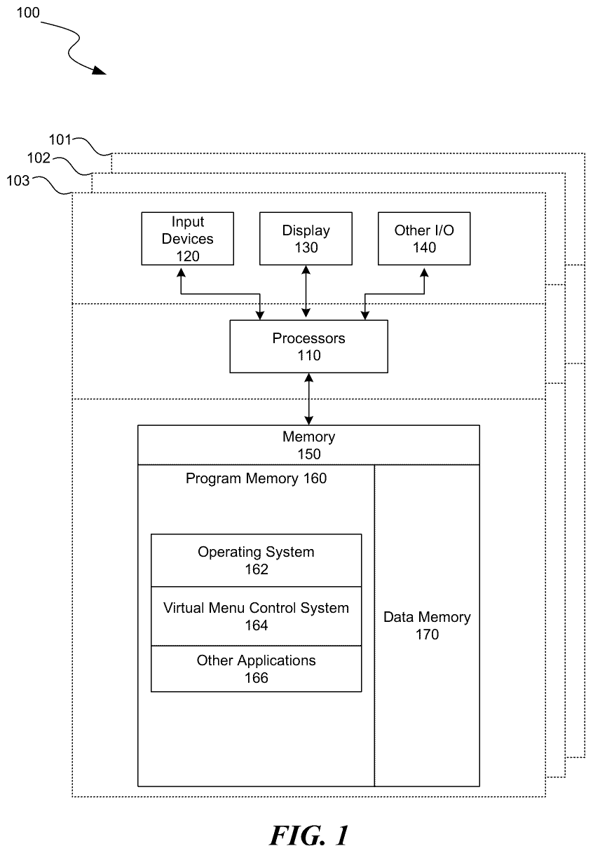

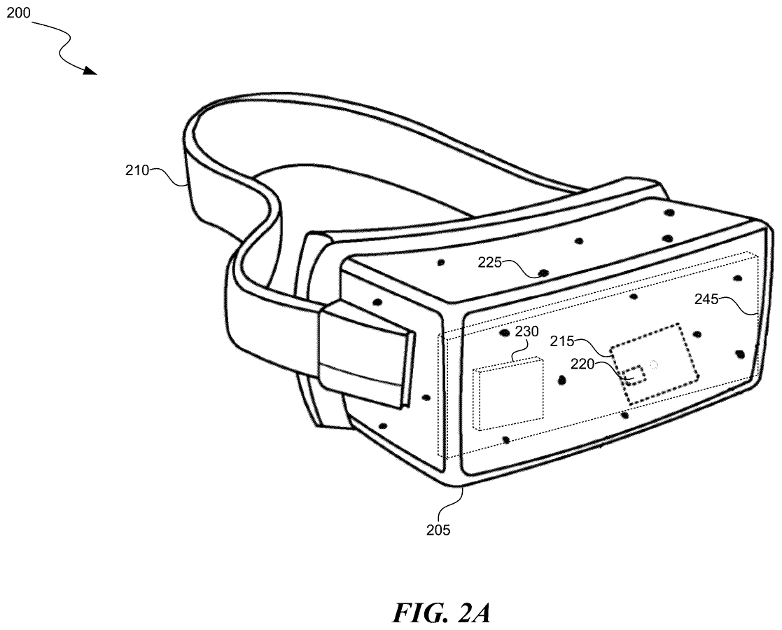

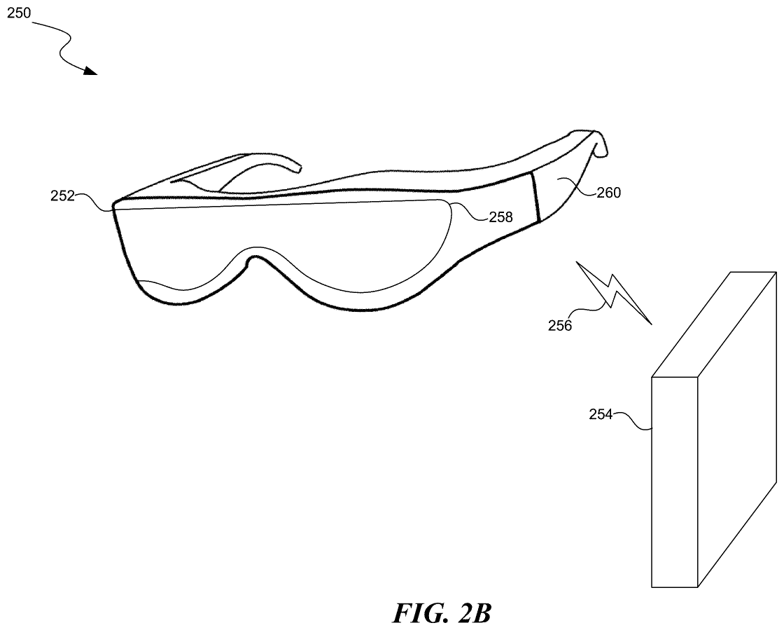

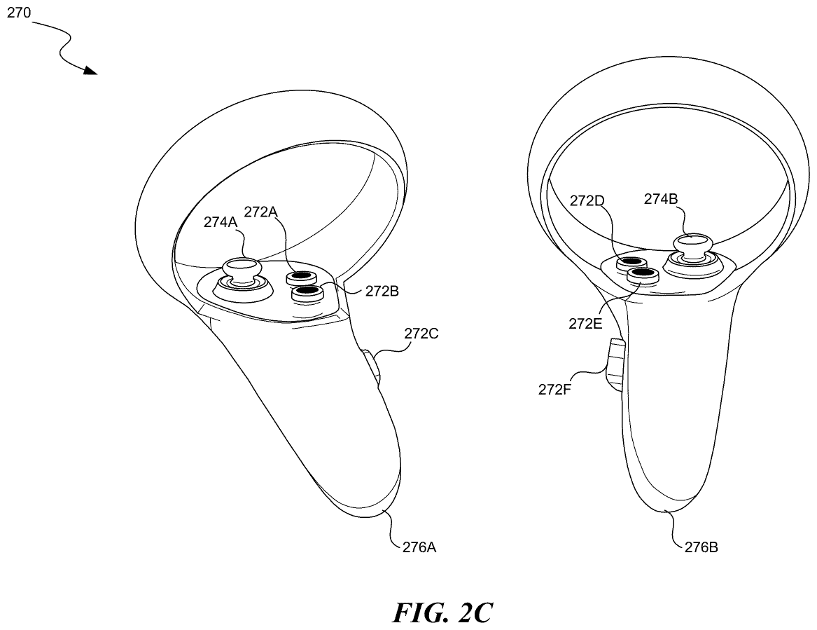

Several implementations are discussed below in more detail in reference to the figures. FIG. 1 is a block diagram illustrating an overview of devices on which some implementations of the disclosed technology can operate. The devices can comprise hardware components of a computing system 100 that can control actions on an artificial reality (XR) device via a virtual menu in an XR environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, virtual menu control system 164, and other application programs 166. Memory 150 can also include data memory 170 that can include, e.g., gesture detection data, gesture identification data, virtual menu data, selectable element data, rendering data, action data, sub-action data, movement detection data, sensor data, image data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3 DoF) or six degrees of freedom (6 DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHZ link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3 DoF or 6 DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3 DoF or 6 DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

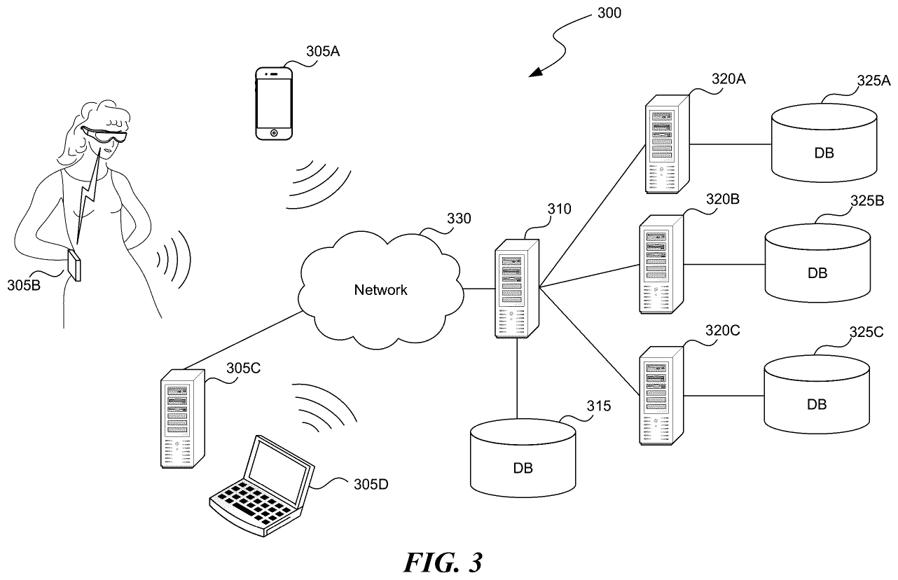

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

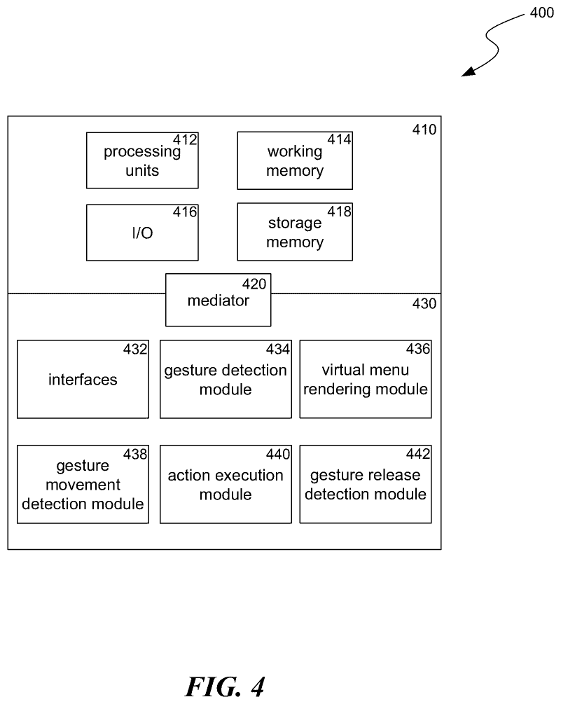

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

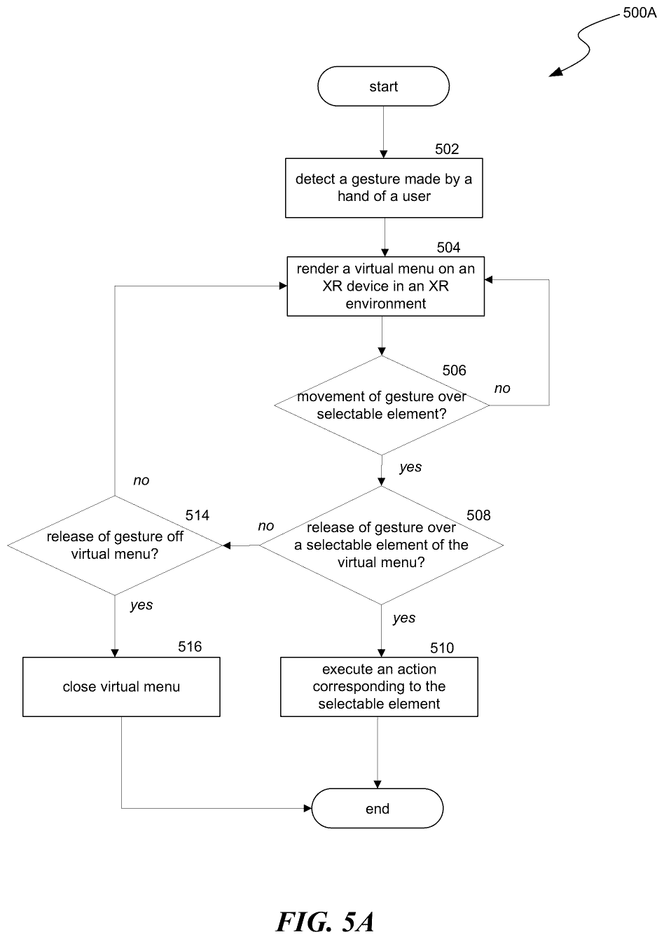

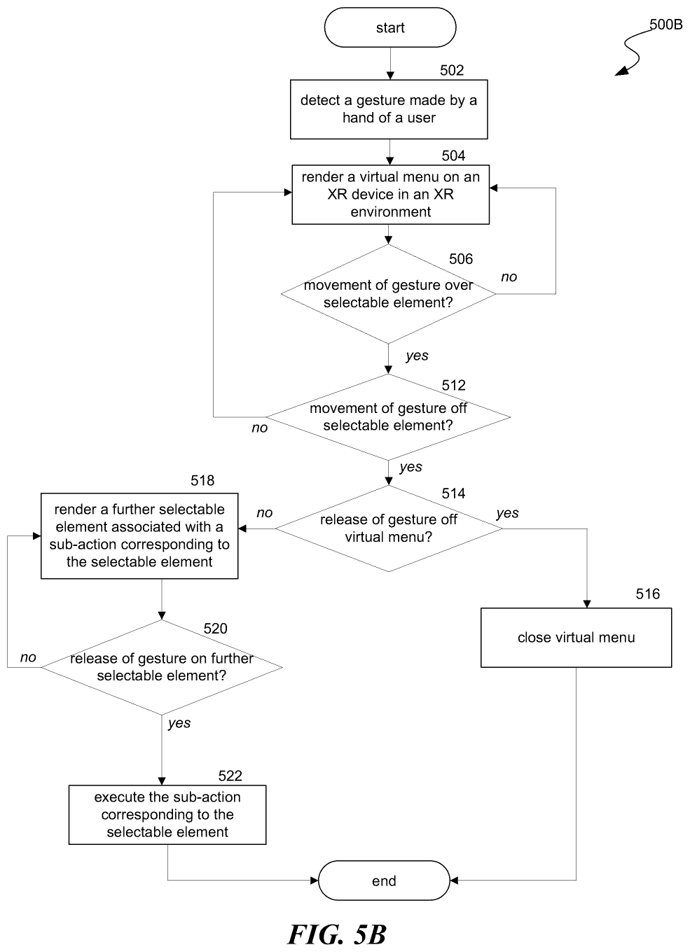

Specialized components 430 can include software or hardware configured to perform operations for controlling actions on an artificial reality (XR) device via a virtual menu in an XR environment. Specialized components 430 can include gesture detection module 434, virtual menu rendering module 436, gesture movement detection module 438, action execution module 440, gesture release detection module 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications. In some implementations, specialized components 430 can be included in virtual menu control system 164 of FIG. 1. In some implementations, specialized components 430 can execute process 500A of FIG. 5A and/or process 500B of FIG. 5B. In some implementations, one or more of specialized components 430 can be omitted in order to execute the functions of process 500A of FIG. 5A and/or process 500B of FIG. 5B.

Gesture detection module 434 can detect a gesture made by a hand of a user in an XR environment. In some implementations, gesture detection module 434 can detect the gesture using one or more cameras, which can be included in input/output devices 416 in some implementations. For example, gesture detection module 434 can use images captured by the one or more cameras to identify a hand making a particular gesture, such as by applying object recognition techniques and/or a machine learning model to the images. For example, gesture detection module 434 can identify relevant features in the images and compare the identified features to features in images of known, preidentified hands, and in some implementations, hands making particular gestures. In some implementations, gesture detection module 434 can detect the gesture without the use of handheld controllers (e.g., controllers 276A and/or 276B of FIG. 2C).

In some implementations, gesture detection module 434 can identify and/or confirm that a hand is making a particular gesture using one or more sensors of a wearable or handheld device (e.g., a smart wristband, a smart watch, a controller, etc.). The wearable or handheld device can include, for example, one or more sensors of an inertial measurement unit (IMU), such as an accelerometer, a gyroscope, a compass, etc., which can capture waveforms indicative of movement of the device. The features of the waveforms can then be compared to features of waveforms captured by similar devices, either individually or as a whole, of known, preidentified movements, such as a hand making a gesture, in order to identify the gesture. In some implementations, gesture detection module 434 can apply a machine learning model trained on known, preidentified IMU waveforms to identify the gesture from one or more newly captured waveforms.

In some implementations, gesture detection module 434 can identify and/or confirm that a hand is making a particular gesture using one or more electromyography (EMG) sensors of a wearable device worn on the arm, wrist, hand, or fingers of the user. The one or more EMG sensors can capture waveforms indicative of electrical activity in the muscles of the user as the user makes a particular gesture. Similar to waveforms captured by an IMU, the features of the EMG waveform can be compared to features of waveforms captured by other EMG sensors of users making known gestures, in order to identify the gesture. In some implementations, gesture detection module 434 can apply a machine learning model trained on known, preidentified EMG waveforms to identify the gesture from a newly captured EMG waveform. Further details regarding detecting a gesture made by a hand of a user of an XR device are described herein with respect to block 502 of FIGS. 5A and 5B.

Virtual menu rendering module 436 can, based on the gesture detected by gesture detection module 434, render a virtual menu on the XR device in the XR environment. In some implementations, such as in mixed reality (MR) or augmented reality (AR), virtual menu rendering module 436 can render the virtual menu as an overlay onto a view of a real-world environment surrounding the XR device. In some implementations, such as in virtual reality (VR), virtual menu rendering module 436 can render the virtual menu as an overlay onto a fully immersive, computer-generated artificial environment. In some implementations, virtual menu rendering module 436 can render the virtual menu as being world-locked (i.e., fixed relative to a certain location in the XR environment), while in other implementations, virtual menu rendering module 436 can render the virtual menu as being body-locked to the user (e.g., fixed relative to a wrist of the user in the XR environment).

The virtual menu can include one or more virtual objects (e.g., selectable elements) corresponding to information, options, functions, and/or actions that can be taken on the XR device. In some implementations, one or more of the virtual objects can correspond to system-level information or actions (e.g., time, date, battery level, weather, temperature, performance metrics, recentering user interface, muting or unmuting the microphone, activating or deactivating passthrough mode, recording a video, taking a screen shot, launching an assistant, etc.). In some implementations, the virtual objects can include selectable elements corresponding to one or more contextual actions relative to an XR experience being executed on the XR device (e.g., while watching a movie, the quick actions can include pause, play, fast forward, rewind, stop, changing playback speed, etc.). In some implementations, the virtual objects can be selected or customized by a user of the XR device, including the order or placement of the virtual objects within the virtual menu. Further details regarding rendering a virtual menu on an XR device in an XR environment are described herein with respect to block 504 of FIGS. 5A and 5B.

Gesture movement detection module 438 can determine whether there is movement of the gesture, detected by gesture detection module 434, over a selectable element rendered by virtual menu rendering module 436. Gesture movement detection module 438 can determine whether there is movement of the gesture over a selectable element by tracking the hand of the user in the XR environment using one or more cameras, e.g., cameras included in input/output devices 416, which, in some implementations, can be the same cameras used to detect the gesture. Gesture movement detection module 438 can determine whether the gesture has been moved over a selectable element by tracking the location of the user's hand in the real-world environment, correlated to the location of a virtual hand in the XR environment, relative to a selectable element in the XR environment on the XR device's coordinate system. Further details regarding determining whether a gesture is moved over a selectable element in an XR environment are described herein with respect to block 506 of FIGS. 5A and 5B.

In some implementations, gesture release detection module 442 can determine whether the gesture, determined to be over a selectable element by gesture movement detection module 438, has been released over the selectable element. Similar to detecting movement of the gesture, gesture release detection module 442 can track the user's hand using one or more cameras to determine whether the gesture has been released and where (e.g., for a pointing gesture, the hand has been closed or open). In some implementations, the release of the gesture can be the user making a different gesture with his hand other than the initial gesture used to cause display of the virtual menu. Further details regarding determining whether a gesture has been released over a selectable element of a virtual menu are described herein with respect to block 508 of FIG. 5A.

In some implementations, if gesture release detection module 442 determines that the gesture has been released over a selectable element, action execution module 440 can execute the action corresponding to the selectable element. For example, for a selectable element corresponding to a particular XR experience (e.g., providing a snapshot of that experience), action execution module 440 can launch the XR experience. In another example, for a video call, action execution module 440 can turn a microphone on or off when the gesture has been released over the corresponding selectable element. Further details regarding executing an action corresponding to a selectable element are described herein with respect to block 510 of FIG. 5A.

In some implementations, if gesture release detection module 442 determines that the gesture has not been released over a selectable element, gesture release detection module 442 can determine whether the gesture was released off of the virtual menu rendered by virtual menu rendering module 436. In some implementations, gesture release detection module 442 can determine whether the gesture was released off of the virtual menu by the same methods used to determine whether the gesture was released over a selectable element, e.g., by tracking movement of the user's hand relative to the virtual menu and determining a location of the gesture release. Further details regarding determining whether a gesture was released off of a virtual menu are described herein with respect to block 514 of FIG. 5B.

In some implementations, if gesture release detection module 442 determines that the gesture was not released off of the virtual menu, virtual menu rendering module 436 can render a further selectable element associated with a sub-action corresponding to the selectable element. For example, the user can make a pinch gesture facing himself to cause virtual menu rendering module 436 to display a set of actions on the virtual menu; move the pinch gesture over or under a brightness control selectable element to highlight that selectable element; then move the pinch gesture off of the selectable element to cause display of a further selectable element, e.g., a slider for changing the brightness of the display of the XR device. Further details regarding rendering a further selectable element associated with a sub-action corresponding to a selectable element are described herein with respect to block 518 of FIG. 5B.

In some implementations, gesture release detection module 442 can determine whether the gesture was released on the further selectable element rendered by virtual menu rendering module 436. In some implementations, gesture release detection module 442 can determine whether the gesture was released off on the further selectable element by the same methods used to determine whether the gesture was released over a selectable element, e.g., by tracking movement of the user's hand relative to the further selectable element and determining a location of the gesture release. If gesture release detection module 442 determines that the gesture was not released on the further selectable element, virtual menu rendering module 436 can continue to render the further selectable element. Further details regarding determining whether a gesture is released on a further selectable element are described herein with respect to block 520 of FIG. 5B.

In some implementations, if gesture release detection module 442 determines that the gesture was released on the further selectable element, action execution module 440 can execute the sub-action corresponding to the selectable element. In the above example, the user can drag the pinch gesture up and down on a slider controlling the brightness of the display on the XR device, which, in some implementations, can cause a preview of the adjusted brightness on the XR device. The location on the slider where the user released the gesture can cause the brightness to remain at the selected level. Further details regarding executing a sub-action corresponding to a selectable element are described herein with respect to block 522 of FIG. 5B.

In some implementations, if gesture release detection module 442 determines that the gesture was released off of the virtual menu, virtual menu rendering module 436 can close the virtual menu, i.e., can stop rendering the virtual menu on the XR device. However, it is contemplated that one or more alternative or additional actions can cause virtual menu rendering module 436 to close the virtual menu, such as the user making a different gesture on or off the virtual menu (e.g., opening the hand, closing the hand, turning the hand in the opposite direction, etc.), the user making a voice command to close the virtual menu (as captured and understood by the XR device), an explicit user selection of a virtual or physical button associated with closing the virtual menu, the user placing the XR device in a standby or deactivated mode, etc. Further details regarding closing a virtual menu are described herein with respect to block 516 of FIGS. 5A and 5B.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5A is a flow diagram illustrating a process 500A used in some implementations of the present technology for controlling an action, on an artificial reality (XR) device, with a gesture made and released relative to a selectable element on a virtual menu displayed in an XR environment. In some implementations, process 500A can be performed as a response to detection of a particular gesture made by a hand of a user, the particular gesture being associated with launch of a virtual menu in the XR environment. In some implementations, process 500A can be partially or fully performed by an XR device, such as an XR head-mounted display (HMD) (e.g., XR HMD 200 of FIG. 2A and/or XR HMD 252 of FIG. 2B), including its integral components. In some implementations, process 500A can be partially or fully performed by one or more other XR devices in an XR system, such as one or more handheld controllers (e.g., controllers 276A and/or 276B of FIG. 2C), external processing components, etc. In some implementations, process 500A can be performed by virtual menu control system 164 of FIG. 1.

At block 502, process 500A can detect a gesture made by a hand of a user. In some implementations, the gesture can be made in an XR environment, such as an augmented reality (AR) or mixed reality (MR) environment in which virtual objects are overlaid onto a view of a real-world environment of the user, and in which the user's physical hand can be seen through the XR device. In some implementations, the gesture can be made in a fully immersive virtual reality (VR) environment including computer-generated images in which the user's physical hand can be mapped to a virtual hand displayed on the XR device.

Although described herein as the gesture being made by a hand of the user, it is contemplated that the gesture can be made by one or more fingers and/or one or both hands of the user of the XR device. In some implementations, process 500A can detect the gesture via one or more cameras integral with or in operable communication with the XR device, such as cameras positioned on an XR HMD pointed away from the user's face. For example, process 500A can capture one or more images of the user's hand and/or fingers in front of the XR device while making a particular gesture. Process 500A can perform object recognition on the captured image(s) to identify a user's hand and/or fingers making a particular gesture (e.g., pointing, snapping, tapping, pinching, etc.). In some implementations, process 500A can use a machine learning model to identify the gesture from the image(s). For example, process 500A can train a machine learning model with images capturing known gestures, such as images showing a user's hand making a fist, a user's finger pointing, a user making a sign with her fingers, a user placing her pointer finger and thumb together, etc. Process 500A can identify relevant features in the images, such as edges, curves, and/or colors indicative of fingers, a hand, etc., making a particular gesture. Process 500A can train a machine learning model using these relevant features of known gestures. Once the model is trained with sufficient data, process 500A can use the trained model to identify relevant features in newly captured image(s) and compare them to the features of known gestures. In some implementations, process 500A can use the trained model to assign a match score to the newly captured image(s), e.g., 80%. If the match score is above a threshold, e.g., 70%, process 500A can classify the motion captured by the image(s) as being indicative of a particular gesture. In some implementations, process 500A can further receive feedback from the user regarding whether the identification of the gesture was correct, and update the trained model accordingly.

In some implementations, process 500A can determine one or more motions associated with a predefined gesture by analyzing a waveforms indicative of electrical activity of the one or more muscles of the user using one or more wearable electromyography (EMG) sensors, such as on an EMG wristband in operable communication with the XR HMD. For example, the one or more motions can include movement of a hand, movement of one or more fingers, etc., when at least one of the one or more EMG sensors is located on or proximate to the wrist, hand, and/or one or more fingers. Process 500A can analyze the waveform captured by one or more EMG sensors worn by the user by, for example, identifying features within the waveform and generating a signal vector indicative of the features. In some implementations, process 500A can compare the signal vector to known gesture vectors stored in a database to identify if any of the known gesture vectors matches the signal vector within a threshold, e.g., is within a threshold distance of a known threshold vector (e.g., the signal vector and a known gesture vector have an angle therebetween that is lower than a threshold angle). If a known gesture vector matches the signal vector within the threshold, process 500A can determine the gesture associated with the vector, e.g., from a look-up table.

In some implementations, process 500A can detect a gesture based on motion data collected from one or more sensors of an inertial measurement unit (IMU), integral with or in operable communication with the XR HMD (e.g., in a smart device, such as a smart wristband, or a controller in communication with the XR HMD), to identify and/or confirm one or more motions of the user indicative of a gesture. The measurements may include the non-gravitational acceleration of the device in the x, y, and z directions; the gravitational acceleration of the device in the x, y, and z directions; the yaw, roll, and pitch of the device; the derivatives of these measurements; the gravity difference angle of the device; and the difference in normed gravitational acceleration of the device. In some implementations, the movements of the device may be measured in intervals, e.g., over a period of 5 seconds.

For example, when motion data is captured by a gyroscope and/or accelerometer in an IMU of a controller (e.g., controller 276A and/or controller 276B of FIG. 2C), process 500A can analyze the motion data to identify features or patterns indicative of a particular gesture, as trained by a machine learning model. For example, process 500A can classify the motion data captured by the controller as a tapping motion based on characteristics of the device movements. Exemplary characteristics include changes in angle of the controller with respect to gravity, changes in acceleration of the controller, etc.

Alternatively or additionally, process 500A can classify the device movements as particular gestures based on a comparison of the device movements to stored movements that are known or confirmed to be associated with particular gestures. For example, process 500A can train a machine learning model with accelerometer and/or gyroscope data representative of known gestures, such as pointing, snapping, pinching, tapping, clicking, etc. Process 500A can identify relevant features in the data, such as a change in angle of the device within a particular range, separately or in conjunction with movement of the device within a particular range. When new input data is received, i.e., new motion data, process 500A can extract the relevant features from the new accelerometer and/or gyroscope data and compare it to the identified features of the known gestures of the trained model. In some implementations, process 500A can use the trained model to assign a match score to the new motion data, and classify the new motion data as indicative of a particular gesture if the match score is above a threshold, e.g., 75%. In some implementations, process 500A can further receive feedback from the user regarding whether an identified gesture is correct to further train the model used to classify motion data as indicative of particular gestures.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the machine learning model can be a neural network with multiple input nodes that receive data about hand and/or finger positions or movements. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer,”) one or more nodes can produce a value classifying the input that, once the model is trained, can be interpreted as wave properties. In some implementations, such neural networks, known as deep neural networks, can have multiple layers of intermediate nodes with different configurations, can be a combination of models that receive different parts of the input and/or input from other parts of the deep neural network, or are convolutions or recurrent-partially using output from previous iterations of applying the model as further input to produce results for the current input.

A machine learning model can be trained with supervised learning, where the training data includes hand and/or finger positions or movements as input and a desired output, such as an identified gesture. A representation of hand and/or finger positions or movements can be provided to the model. Output from the model can be compared to the desired output for that input and, based on the comparison, the model can be modified, such as by changing weights between nodes of the neural network or parameters of the functions used at each node in the neural network (e.g., applying a loss function). After applying the input in the training data and modifying the model in this manner, the model can be trained to evaluate new data. Similar training procedures can be used for the various machine learning models discussed above.

It is contemplated that process 500A can identify any suitable gesture that can be associated with or indicative of an intention to open a virtual menu. For example, process 500A can identify a pinch gesture (facing toward or away from the user), a tap gesture, a pointing gesture, a circling gesture, a movement in a particular direction, etc. In some implementations, process 500A can alternatively or additionally receive input associated with or indicative of an intention open the virtual menu from an input device, such as one or more handheld controllers (e.g., controller 276A and/or controller 276B of FIG. 2C) that in some implementations can allow the user to interact with the virtual menu presented by an XR HMD. The controllers can include various buttons and/or joysticks that a user can actuate to provide selection input and interact with the virtual menu. In some implementations, however, it is contemplated that process 500A need not use controllers to identify the gesture and/or to execute actions on the virtual menu, and can perform gesture tracking, gesture identification, and action selection without such controllers.

At block 504, based on the gesture detected at block 502, process 500A can render a virtual menu on the XR device in the XR environment. The virtual menu can include one or multiple selectable elements (e.g., virtual buttons or icons) corresponding to actions that can be taken on the XR device. In some implementations, the actions can include system-level actions controlling system-level functions on the XR device, such as volume controls, display controls, activation or deactivation of functions (e.g., audio capture, image capture, video capture, etc.), display of time or battery level, etc. In some implementations, the actions can include user-customized actions, i.e., actions selected by or generated by the user for display in the virtual menu, e.g., shortcuts to launch certain applications, system functions, virtual content, etc., such as those that are frequently accessed. In some implementations, the actions can include contextual actions relevant to an XR experience executing on the XR device when the gesture is detected at block 502. For example, if a three-dimensional (3D) movie is playing on the XR device, the virtual menu can include controls for pausing the 3D movie, rewinding the 3D movie, fast forwarding the 3D movie, scrubbing within the 3D movie, etc. In some implementations, the virtual menu can include any combination of such actions.

At block 506, process 500A can determine whether there was movement of the gesture over a selectable element. Process 500A can determine if there was movement of the gesture by, for example, tracking the hand of the user while making the gesture using one or more cameras integral with or in operable communication with the XR device. Additionally or alternatively, process 500A can determine whether there was movement of the gesture via one or more controllers, one or more sensors of an IMU, one or more EMG sensors, etc., as described above with respect to block 502. If process 500A determines that there was not movement of the gesture over a selectable element at block 506, process 500A can return to block 504, and continue to render the virtual menu on the XR device in the XR environment.

If process 500A determines that there was movement of the gesture over a selectable element at block 506, process 500A can proceed to block 508. At block 508, process 500A can determine whether the gesture was released over the selectable element of the virtual menu. Process 500A can determine whether the gesture was released by tracking the movement of the hands using one or more cameras, and/or by any other of the methods described above with respect to block 502 (e.g., using one or more sensors of an IMU, using one or more controllers, using one or more EMG sensors, etc.). If the gesture was released, process 500A can further determine where in the XR environment the gesture was released relative to a selectable element. For example, process 500A can iteratively track the position of the user's hand (e.g., from one or more images), as it relates to a coordinate system of the XR environment. Process 500A can determine a position and/or pose of the hands in the real-world environment relative to the XR device using one or more of the techniques described above, which can then be translated into the XR device's coordinate system. Once on the XR device's coordinate system, process 500A can determine a virtual location in the XR environment of the gesture relative to a location of a selectable element on the XR device's coordinate system, e.g., proximate to (e.g., over or under the selectable element), or not proximate to a selectable element.

If process 500A determines that the gesture wasn't released over a selectable element of the virtual menu at block 508, process 500A can continue to block 514. At block 514, process 500A can determine whether the gesture was released off the virtual menu, by similar methods as described above with respect to block 508. If the gesture wasn't released off of the virtual menu, process 500A can return to block 504, and continue rendering the virtual menu on the XR device in the XR environment. Alternatively or additionally to performing block 514, in some implementations, process 500A can determine whether audio input has been received from the user (e.g., via one or more microphones) to close the virtual menu, i.e., by the user speaking, “I want to close the virtual menu.” Still further, alternatively or additionally to performing block 514, process 500A can determine whether a further gesture has been made by the user (e.g., using any of the methods described herein) indicative of an intention to close the virtual menu, e.g., turning the gesture away from the XR device, and/or performing a different gesture, such as closing or opening of the hand. If process 500A determines at block 514 that the gesture was released off of the virtual menu at block 508 (and/or by another method indicating that the virtual menu should be closed), process 500A can proceed to block 516. At block 516, process 500A can close the virtual menu, i.e., terminate rendering of the virtual menu on the XR device.

If process 500A determines that the gesture was released over a selectable element of the virtual menu at block 508, process 500A can continue to block 510. At block 510, process 500A can execute the action corresponding to the selectable element. Process 500A can determine the action corresponding to the selectable element by, for example, accessing a look-up table storing an identifier of the selectable element in correspondence with an action to be taken if the selectable element is selected. Process 500A can execute the action by executing lines of code corresponding to the action identified in the look-up table. For example, process 500A can turn on or off a microphone, launch an XR experience or application, launch a system utility tool (e.g., a calculator, a timer, etc.), adjust system settings (e.g., display settings, brightness settings, etc.), display relevant system information, and/or the like.

FIG. 5B is a flow diagram illustrating a process 500B used in some implementations of the present technology for controlling a sub-action, on an artificial reality (XR) device, with a gesture by dragging the gesture off a selectable element in a virtual menu displayed in an XR environment. In some implementations, process 500B can be performed as a response to detection of a particular gesture made by a hand of a user, the particular gesture being associated with launch of a virtual menu in the XR environment. In some implementations, process 500B can be partially or fully performed by an XR device, such as an XR head-mounted display (HMD) (e.g., XR HMD 200 of FIG. 2A and/or XR HMD 252 of FIG. 2B), including its integral components. In some implementations, process 500B can partially or fully performed by one or more other XR devices in an XR system, such as one or more handheld controllers (e.g., controllers 276A and/or 276B of FIG. 2C), external processing components, etc. In some implementations, process 500B can be performed by virtual menu control system 164. In some implementations, one or more blocks of process 500B can be performed prior to, after, concurrently with, and/or simultaneously with one or more blocks of process 500A of FIG. 5A., with or without reperformance of their duplicative steps.

At block 502, process 500B can detect a gesture made by a hand of a user of the XR device in the XR environment. At block 504, based on the detected gesture, process 500B can render a virtual menu on an XR device in the XR environment. The virtual menu can include multiple selectable elements, each of which can be associated with an action on the XR device. At block 506, process 500B can determine whether there was movement of the gesture over a selectable element. If process 500B determines that there was not movement of the gesture over a selectable element at block 506, process 500B can return to block 504, and continue to render the virtual menu on the XR device in the XR environment. Process 500B can perform blocks 502-506 as described above with respect to process 500A of FIG. 5A.

If process 500B determines that there was movement of the gesture over a selectable element at block 506, process 500B can proceed to block 512. At block 512, process 500B can determine whether movement of the gesture was from over a selectable element to off of the selectable element. Similar to that described above with respect to block 508 of FIG. 5A, process 500B can determine movement of the gesture was from over to off of a selectable element by tracking the movement of the hands using one or more cameras, and/or by any other of the methods described above with respect to block 502 (e.g., using one or more sensors of an IMU, using one or more controllers, using one or more EMG sensors, etc.). For example, process 500B can iteratively track the position of the user's hand (e.g., from one or more images), as it relates to a coordinate system of the XR environment. Process 500B can determine a position and/or pose of the hands in the real-world environment relative to the XR device using one or more of the techniques described above, which can then be translated into the XR device's coordinate system. Once on the XR device's coordinate system, process 500B can determine a virtual location in the XR environment of the movement relative to a location of a selectable element on the XR device's coordinate system, e.g., proximate to (e.g., overlapping) the selectable element, then off of the selectable element.

If process 500B determines that movement of the gesture was not off of a selectable element, process 500B can return to block 504, and continue rendering the virtual menu on the XR device in the XR environment. If process 500B determines that movement of the gesture was off of a selectable element, process 500B can proceed to block 514. At block 514, process 500B can determine whether the gesture was released off of the virtual menu. If process 500B determines that the gesture was released off of the virtual menu at block 514, process 500B can proceed to block 516. At block 516, process 500B can close the virtual menu. Process 500B can perform blocks 514-516 as described above with respect to process 500A of FIG. 5A.

If process 500B determines that the gesture was not released off of the virtual menu at block 514, process 500B can proceed to block 518. At block 518, process 500B can execute the action corresponding to the selectable element, which, in some implementations, can be to render a further selectable element associated with a sub-action corresponding to the selectable element. For example, based on movement of the gesture from over a volume control selectable element to off of the volume control selectable element in the virtual menu, process 500B can render a volume slider as a further selectable element that a user can adjust to control the volume of audio being rendered on the XR device.

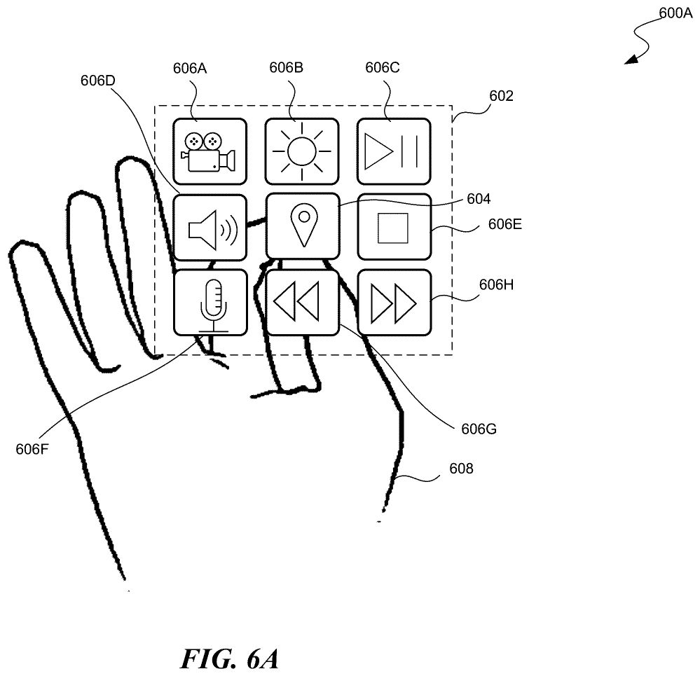

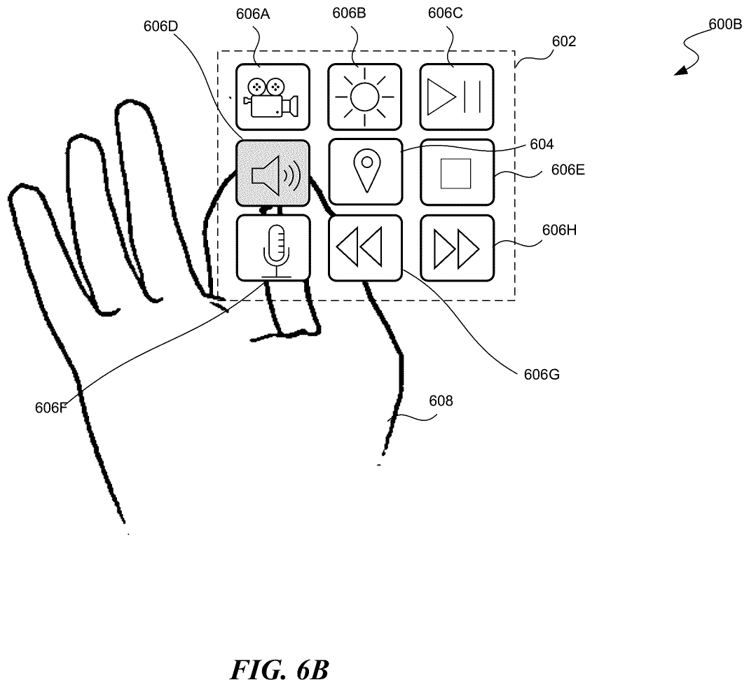

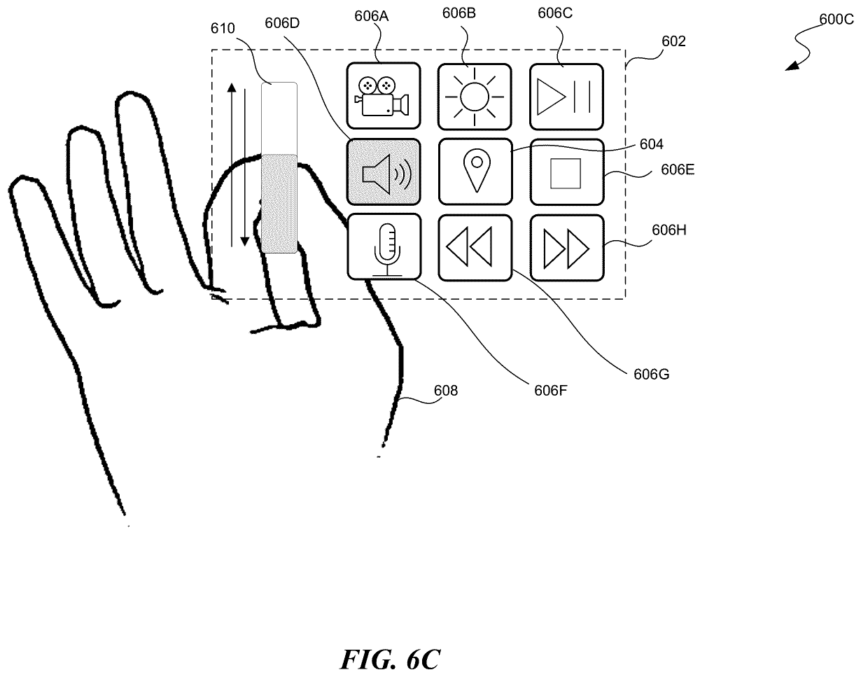

At block 520, process 500B can determine whether the gesture was released relative to (e.g., on or over) the further selectable element. Process 500B can determine whether the gesture was released relative to the further selectable element similar to that described with respect to block 508 of process 500A. If process 500B determines that the gesture was not released on the further selectable element, process 500B can return to block 518, and continue rendering the further selectable element. If process 500B determines that the gesture was released relative to the further selectable element, process 500B can proceed to block 522. At block 522, process 500B can execute the sub-action corresponding to the selectable element. Process 500B can determine the sub-action corresponding to the selectable element by, for example, accessing a look-up table storing identifiers of the selectable element and further selectable element in correspondence with an action to be taken if the further selectable element is selected. Process 500B can execute the sub-action by executing lines of code corresponding to the sub-action identified in the look-up table. For example, process 500B can adjust the system volume in correspondence with a virtual slider. An exemplary view on an XR device of a virtual slider being displayed based on movement of a hand off of a volume control selectable element are shown and described with respect to FIGS. 6B-6C herein.

FIG. 6A is a conceptual diagram illustrating an example view 600A on an artificial reality (XR) device of a virtual menu 602 having a block configuration displayed based on detection of a gesture of a hand 608. The XR device can capture the gesture made by hand 608, which, in example view 600A, is a pinch gesture facing the XR device. Upon detection of the pinch gesture facing the XR device, the XR device can render virtual menu 602. In some implementations, the XR device can render virtual menu 602 centered on the user's pinch gesture when the pinch gesture is initially made, i.e., with selectable elements 606A-H surrounding the user's pinch gesture. In some implementations, the XR device can further render a home button 604 in the center of virtual menu 602, which, in some implementations, can merely indicate that hand 608 is not positioned relative to one of selectable elements 606A-H (i.e., on, over, behind, or overlapping a selectable element). Selectable elements 606A-H can include system-level selectable elements, user-customized selectable elements, selectable elements contextual to the XR environment or the real-world environment of the user, and/or XR experience-specific selectable elements. Although illustrated as including only graphics on selectable elements 606A-H, it is contemplated that selectable elements 606A-H can alternatively or additionally include text describing their associated information or actions. Additionally, although described as being selectable elements 606A-H, it is contemplated that one or more of selectable elements 606A-H can merely be informational.

FIG. 6B is a conceptual diagram illustrating an example view 600B on an artificial reality (XR) device of a selectable element 606D being highlighted based on a gesture of a hand 608 on a virtual menu 602 displayed in an XR environment. From example view 600A of FIG. 6A, the user can move hand 608 relative to any of selectable elements 606A-H. For example, in example view 600B, the user can move hand 608 such that the pinch gesture is under selectable element 606D, indicating the user's intention to interact with selectable element 606D. While the pinch gesture is under selectable element 606D, the XR device can, in some implementations, highlight (or render some other indicator) of selectable element 606D relative to other selectable elements 606A-C, 606E-H. While highlighted, it is contemplated that, in some implementations, selectable element 606D can render additional information about its associated action, such as text (not shown), and/or can cause an audible announcement of further information about its associated action.

FIG. 6C is a conceptual diagram illustrating an example view 600C on an artificial reality (XR) device of a further selectable element 610 being displayed in a virtual menu 602. Further selectable element 610 can correspond to a sub-action of highlighted selectable element 606D. The XR device can display further selectable element 610 based on movement of the gesture of hand 608 off of highlighted selectable element 606D. In other words, selectable element 606D can have a corresponding action of displaying further selectable element 610 when the XR device detects that hand 608, making the pinch gesture, is moved from under selectable element 606D to off of and away from selectable element 606D. In example view 600C, selectable element 606D can be an audio control selectable element, and further selectable element 610 can be a slider. The user can move hand 608 up and down in the pinch gesture relative to further selectable element 610 to adjust the volume level being output by the XR device.

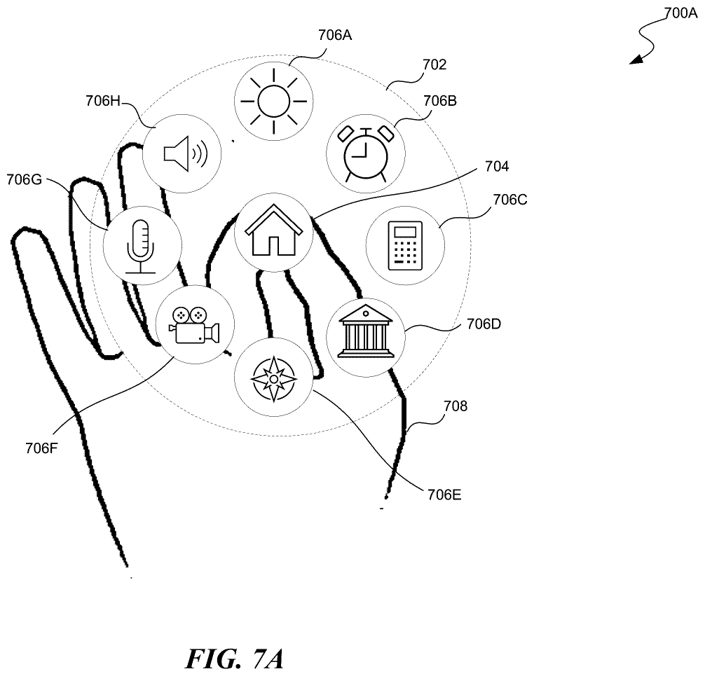

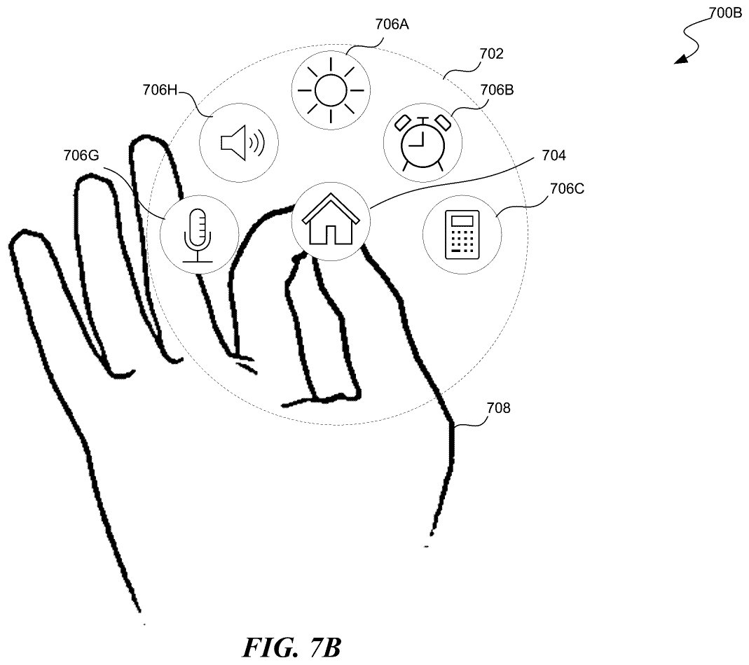

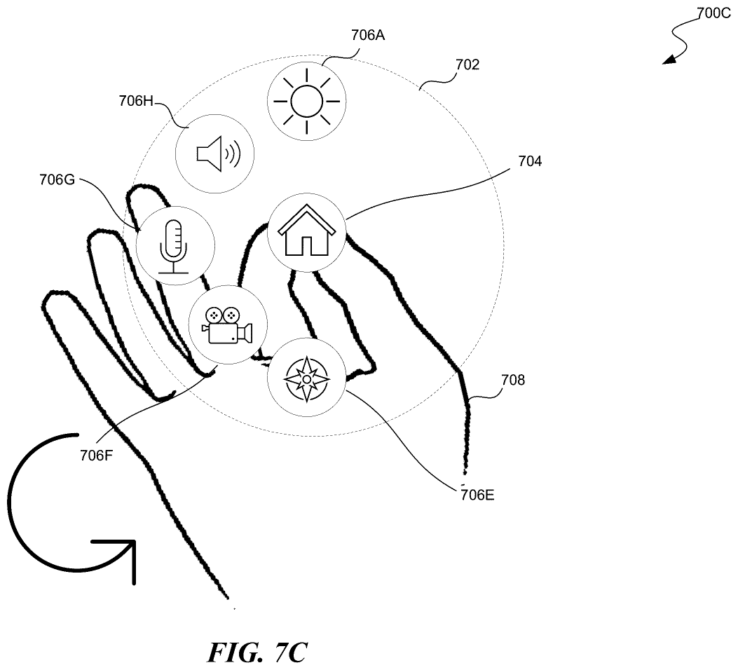

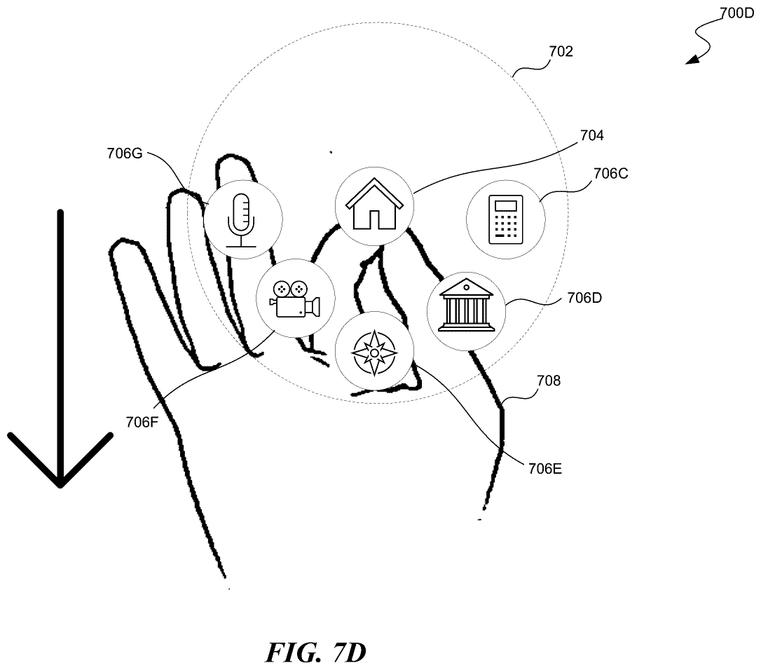

FIG. 7A is a conceptual diagram of an example view 700A on an artificial reality (XR) device of a virtual menu 702 having a radial configuration displayed in an XR environment based on detection of a gesture of a hand 708. The XR device can capture the gesture made by hand 708, which, in example view 700A, is a pinch gesture facing the XR device. Upon detection of the pinch gesture facing the XR device, in some implementations, the XR device can render virtual menu 702 in a radial configuration. In some implementations, the XR device can render virtual menu 702 centered on the user's pinch gesture when the pinch gesture is initially made, i.e., with selectable elements 706-H surrounding the user's pinch gesture. In some implementations, the XR device can further render a home button 704 in the center of virtual menu 702, which, in some implementations, can merely indicate that hand 708 is not positioned relative to one of selectable elements 706A-H (i.e., not on, over, behind, or overlapping a selectable element). Selectable elements 706A-H can include system-level selectable elements, user-customized selectable elements, selectable elements contextual to the XR environment or the real-world environment of the user, and/or XR experience-specific selectable elements.

FIG. 7B is a conceptual diagram of an example view 700B on an artificial reality (XR) device of particular selectable elements 706A-C, 706G-H being displayed in a virtual menu based on a forward push motion of a gesture of a hand 708. In some implementations, alternative to example view 700A of FIG. 7A, the XR device can merely display home button 704 responsive to detecting the pinch gesture of hand 708. The XR device can then detect a forward push motion of hand 708 while making the pinch gesture. Responsive to detecting the forward push motion, the XR device can render a certain set of selectable elements 706A-C, 706G-H, instead of rendering all of selectable elements 706A-H as in FIG. 7A. In some implementations, the certain set of selectable elements 706A-C, 706G-H can correspond to the selectable elements positioned at the top of virtual menu 702. In some implementations, the certain set of selectable elements 706A-C, 706G-H can include particular types of selectable elements, e.g., selectable elements corresponding to system-level actions. As shown in example view 700B, the certain set of selectable elements 706A-C, 706G-H can partially surround home button 704 where the forward push motion was made.

FIG. 7C is a conceptual diagram of an example view 700C on an artificial reality (XR) device of particular selectable elements 706A, 706E-H being displayed in a virtual menu 702 based on a wrist rotation of hand 708 while performing a gesture. In some implementations, the XR device can detect rotation of hand 708 relative to virtual menu 702 while making a pinch gesture, in this example. In response to detecting rotation of hand 708, the XR device can render example view 700C in which particular selectable elements 706A, 706E-H are displayed. In some implementations, particular selectable elements 706A, 706E-H can be selected from selectable elements 706A-H based on a direction of rotation of the wrist. In some implementations, the certain selectable elements 706A, 706E-H can include particular types of selectable elements, e.g., selectable elements most frequently accessed. As shown in example view 700C, the certain selectable elements 706A, 706E-H can partially surround home button 704 where the gesture was made.

FIG. 7D is a conceptual diagram of an example view 700D on an artificial reality (XR) device of particular selectable elements 706C-G being displayed in a virtual menu 702 based on a downward motion of a gesture of a hand 708. In some implementations, the XR device can detect downward motion of hand 708 relative to virtual menu 702 while making a pinch gesture, in this example. In response to detecting downward motion of hand 708, the XR device can render example view 700D in which particular selectable elements 706C-G are displayed. In some implementations, particular selectable elements 706C-G can be selected from selectable elements 706A-H based on a direction of the motion of hand 708, e.g., the lower half of selectable elements 706A-H can be displayed for a downward motion, the upper half of selectable elements 706A-H can be displayed for an upward motion, etc. In some implementations, the certain selectable elements 706C-G can include particular types of selectable elements, e.g., user-customized selectable elements.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or implementations other alternative mutually exclusive of implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/we claim:

1. A method for controlling actions on an artificial reality device via a virtual menu, the method comprising:
detecting, by the artificial reality device, a gesture made by a hand of a user of the artificial reality device, the gesture being made in an artificial reality environment;
based on the detected gesture, rendering the virtual menu on the artificial reality device in the artificial reality environment, the virtual menu including multiple selectable elements, each selectable element being associated with an action on the artificial reality device;
detecting movement of the gesture from over a selectable element, of the multiple selectable elements, to off of the selectable element, the movement of the gesture being detected by the artificial reality device tracking the hand of the user;
executing the action corresponding to the selectable element, the action being rendering of a further selectable element, wherein the further selectable element is associated with a sub-action corresponding to the selectable element, and wherein the further selectable element is rendered on the virtual menu in the artificial reality environment;
detecting release of the gesture relative to the further selectable element in the artificial reality environment; and
based on the detected release of the gesture relative to the further selectable element, executing the sub-action corresponding to the selectable element on the artificial reality device.

2. The method of claim 1, wherein the multiple selectable elements are rendered at least partially surrounding the gesture in the artificial reality environment.

3. The method of claim 2,
wherein the multiple selectable elements are multiple first selectable elements, and
wherein the method further comprises:
detecting rotation of the hand of the user relative to the virtual menu in the artificial reality environment; and
in response to detecting rotation of the hand of the user, rendering multiple second selectable elements at least partially surrounding the gesture in a direction of rotation of the hand.

4. The method of claim 2,
wherein the multiple selectable elements are multiple first selectable elements,
wherein the first multiple selectable elements are rendered at least partially surrounding a center, the center corresponding to a location of the gesture,
wherein the center corresponds to no first selectable element, and
wherein the method further comprises:
detecting movement of the hand from the center in a direction away from the center; and
in response to detecting movement of the hand from the center in the direction away from the center, rendering multiple second selectable elements at least partially surrounding the gesture in a direction of movement of the hand from the center.

5. The method of claim 1,
wherein the gesture is a pinch gesture, and
wherein the movement of the gesture is a dragging of the pinch gesture.

6. The method of claim 1, wherein the actions include at least two of:
A) a system-level action controlling system-level functions on the artificial reality device,
B) a user-customized action,
C) a contextual action relative to an artificial reality experience executing on the artificial reality device when the gesture is detected, or
D) any combination thereof.

7. The method of claim 1, further comprising:
detecting further user input, the further user input including at least one of A) a further gesture made by the user of the artificial reality device, B) audible input corresponding to closing the virtual menu, or C) both; and
closing the virtual menu.

8. The method of claim 1,
wherein the further selectable element is a virtual slider, and
wherein further movement of the gesture relative to the virtual slider controls movement of the virtual slider.

9. The method of claim 1, wherein the artificial reality device detects the gesture of the hand of the user without a handheld controller.

10. The method of claim 1, wherein the gesture is detected by one or more cameras integral with the artificial reality device.

11. A computer-readable storage medium storing instructions that, when executed by a computing system, cause the computing system to perform a process for controlling actions on an artificial reality device via a virtual menu, the process comprising:
detecting, by the artificial reality device, a gesture made by a hand of a user of the artificial reality device, the gesture being made in an artificial reality environment;
based on the detected gesture, rendering the virtual menu on the artificial reality device in the artificial reality environment, the virtual menu including multiple selectable elements, each selectable element being associated with an action on the artificial reality device; and
performing either:
A):
detecting movement and release of the gesture over a selectable element, of the multiple selectable elements, in the artificial reality environment, and
executing the action corresponding to the selectable element; or
B):
detecting movement of the gesture from over a selectable element, of the multiple selectable elements, to off of the selectable element, the movement of the gesture being detected by the artificial reality device tracking the hand of the user;
executing the action corresponding to the selectable element, the action being rendering of a further selectable element, wherein the further selectable element is associated with a sub-action corresponding to the selectable element, and wherein the further selectable element is rendered on the virtual menu in the artificial reality environment;
detecting release of the gesture relative to the further selectable element in the artificial reality environment; and
based on the detected release of the gesture relative to the further selectable element, executing the sub-action corresponding to the selectable element on the artificial reality device.

12. The computer-readable storage medium of claim 11, wherein the multiple selectable elements are rendered at least partially surrounding the gesture in the artificial reality environment.

13. The computer-readable storage medium of claim 11,
wherein the multiple selectable elements are multiple first selectable elements, and
wherein the process further comprises:
detecting rotation of the hand of the user relative to the virtual menu in the artificial reality environment; and
in response to detecting rotation of the hand of the user, rendering multiple second selectable elements at least partially surrounding the gesture in a direction of rotation of the hand.

14. The computer-readable storage medium of claim 11,
wherein the multiple selectable elements are multiple first selectable elements,
wherein the first multiple selectable elements are rendered at least partially surrounding a center, the center corresponding to a location of the gesture,
wherein the center corresponds to no first selectable element, and
wherein the process further comprises:
detecting movement of the hand from the center in a direction away from the center; and
in response to detecting movement of the hand from the center in the direction away from the center, rendering multiple second selectable elements at least partially surrounding the gesture in a direction of movement of the hand from the center.

15. The computer-readable storage medium of claim 11,
wherein movement of the gesture from over the selectable element to off the selectable element is detected,
wherein the gesture is a pinch gesture, and
wherein the movement of the gesture is a dragging of the pinch gesture.

16. A computing system for controlling actions on an artificial reality device via a virtual menu, the computing system comprising:
one or more processors; and
one or more memories storing instructions that, when executed by the one or more processors, cause the computing system to perform a process comprising:
detecting, by the artificial reality device, a gesture made by a hand of a user of the artificial reality device, the gesture being made in an artificial reality environment;
based on the detected gesture, rendering the virtual menu on the artificial reality device in the artificial reality environment, the virtual menu including multiple selectable elements, each selectable element being associated with an action on the artificial reality device;
detecting movement and release of the gesture over a selectable element, of the multiple selectable elements, in the artificial reality environment; and
executing the action corresponding to the selectable element.

17. The computing system of claim 16,
wherein the action corresponding to the selectable element is rendering of a further selectable element,
wherein the further selectable element is associated with a sub-action corresponding to the selectable element, and wherein the further selectable element is rendered on the virtual menu in the artificial reality environment;
detecting a further gesture relative to the further selectable element in the artificial reality environment; and
based on the detected further gesture relative to the further selectable element, executing the sub-action corresponding to the selectable element on the artificial reality device.

18. The computing system of claim 17,
wherein the further selectable element is a virtual slider, and
wherein further movement of the gesture relative to the virtual slider controls movement of the virtual slider.

19. The computing system of claim 16, wherein the actions include at least two of:
A) a system-level action controlling system-level functions on the artificial reality device,
B) a user-customized action,
C) a contextual action relative to an artificial reality experience executing on the artificial reality device when the gesture is detected, or
D) any combination thereof.

20. The computing system of claim 16, wherein the process further comprises:
detecting further user input, the further user input including at least one of A) a further gesture made by the user of the artificial reality device, B) audible input corresponding to closing the virtual menu, or C) both; and
closing the virtual menu.
